(19) United States
(12) Patent Application Publication
(10) Pub. No.: US 2011/0095033 A1
(43) Pub. Date: Apr. 28, 2011

(54) Portable Multi-Media Communication Device Protective Carrier and Method of Manufacture Therefor

(75) Inventor: Juliana S. Hung, Arcadia, CA (US)

(73) Assignee: Belkin International, Inc., Playa Vista, CA (US)

(21) Appl. No.: 12/914,995

(22) Filed: Oct. 28, 2010

Related U.S. Application Data
(60) Provisional application No. 61/255,779, filed on Oct. 28, 2009.

(51) Int. Cl. B65D 25/00; B29C 45/00; B29C 33/38; B29C 45/26

(52) U.S. Cl. 220/602; 264/328.1; 264/219

(57) ABSTRACT

Some embodiments disclose a mobile media device case configured to receive and hold a mobile media device. The mobile media device case can include: (a) a back wall; and (b) one or more sidewalls coupled to the back wall. The mobile media device case can translucent. The back wall and the one or more sidewalls can define an interior of the mobile media device case and an interior surface. The mobile media device case can be configured to receive and hold the mobile media device within the interior of the mobile media device case and at least a first portion of the interior surface comprises texturing. Other embodiments and related methods are also disclosed herein.

### CROSS REFERENCE TO RELATED APPLICATION

This application claims priority to U.S. Provisional Patent Application 61/255,779 filed on Oct. 28, 2009, the contents of which are incorporated herein by reference.

### FIELD OF THE INVENTION

This invention relates generally to portable device enclosures, and relates, more particularly, a case/enclosure for a portable digital media player including apparatuses and related methods thereto.

### BACKGROUND

The portable media player market has changed dramatically in the past several years and with it, the portable media player enclosure market. Recent trends have focused on the emergence of the mobile media device, which simply put is a handheld phone incorporating several additional features not found in traditional handheld phones.

Mobile media devices can include one or more of the following features: the merging of a personal data/digital assistant (PDA) and a cellular phone; a keyboard interface (e.g., a QWERTY keyboard) configuration as either a touch screen or tactile keyboard; the capability to receive/download audio/video files. Furthermore, mobile media devices can: run an operating system software providing a standardized interface and platform for application developers; include advanced features like e-mail, Internet access and e-book reader capability; and/or include a built-in full keyboard or external USB keyboard and VGA connector. In other words, a mobile media device can be considered a miniature computer that has telephone capability. One example of a mobile media device is the iPhone® product by Apple Inc. of Cupertino, Calif. Another example of a mobile media device is the Blackberry® product by Research In Motion (RIM) of Waterloo, Ontario, Canada.

Following the introduction of mobile media devices, mobile media device cases were introduced. Unfortunately, current mobile media device cases have many shortcomings. FIG. 1 is a rear view illustrating an embodiment of a conventional mobile media device case 120 enclosing a mobile media device 110.

As shown in FIG. 1, mobile media device case 120 is configured to hold mobile media device 110. Noticeable blemishes and imperfections are visible through mobile media device case 120 and appear on the rear surface of mobile media device 110 or on the interior surface of mobile media device case 120. For example, noticeable blemishes and imperfections 121 are visible through mobile media device case 120 and look like a liquid on the rear surface of mobile media device 110 when viewed through mobile media device case 120. In some embodiments, noticeable blemishes and imperfections 121 may cause device mobile media device case 120 to be unattractive to a potential user/customer.

In some examples, the blemishes and imperfections are caused by the smooth interior surface of mobile media device case 120 touching the polished plastic (or glass or metal) exterior surface of mobile media device 110. When these two smooth or polished surfaces are abutting, blemishes and imperfections 121 can be seen. These blemishes and imperfections can detract from the aesthetic look a transparent mobile media device case.

Additionally, transparent mobile media device cases often allow oils and other moisture content on the back and sides of mobile media devices to congeal and form pools that also can detract from the aesthetic look of a transparent mobile media device case.

Accordingly, a need exists in the art to develop a translucent mobile media device case that will provide damage protection of a mobile media device, provide scratch protection, and be aesthetic pleasing look to the user.

### BRIEF DESCRIPTION OF THE DRAWINGS

The invention will be better understood from a reading of the following detailed description of examples of embodiments, taken in conjunction with the accompanying figures in the drawings in which:

FIG. 1 is a rear view illustrating an embodiment of a conventional mobile media device case enclosing a mobile media device.

FIG. 2 is a rear view illustrating an embodiment of an exemplary mobile media device case enclosing the mobile media device of FIG. 1, according to a first embodiment.

FIG. 3 is a front, right isometric view illustrating the exemplary mobile media device case of FIG. 2, according to the first embodiment.

FIG. 4 is another rear view illustrating the exemplary mobile media device case of FIG. 2, according to the first embodiment.

FIG. 5 is a top, front isometric view illustrating a part of the exemplary mobile media device case of FIG. 2, according to the first embodiment.

FIG. 6 is a front, right view illustrating an embodiment of another exemplary mobile media device case, according to a second embodiment.

FIG. 7 is a right, front isometric view illustrating a part of the exemplary mobile media device case of FIG. 6, according to the second embodiment.

FIG. 8 is a rear view illustrating an embodiment of an exemplary mobile media device case enclosing the mobile media device of FIG. 1, according to a third embodiment.

FIG. 9 is an operational flow diagram generally illustrating a method for manufacturing a mobile media device case, according to an embodiment.

FIG. 10 is an operational flow diagram generally illustrating another method for manufacturing a mobile media device case, according to an embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

Some embodiments disclose a mobile media device case configured to receive and hold a mobile media device. The mobile media device case can include: (a) a back wall; and (b) one or more sidewalls coupled to the back wall. The mobile media device case can translucent. The back wall and the one or more sidewalls can define an interior of the mobile media device case and an interior surface. The mobile media device case can be configured to receive and hold the mobile media device within the interior of the mobile media device case and at least a first portion of the interior surface comprises texturing.

In other examples, a mobile media device case can be configured to receive and hold a mobile media device. The mobile media device case can include: (a) a back wall; and (b) one or more sidewalls coupled to the back wall. The mobile media device case can be translucent. The back wall and the one or more sidewalls can define an interior of the mobile media device case and an interior surface. The mobile media device case can be configured to receive and hold the mobile media device within the interior of the mobile media device case. At least a first portion of the interior surface can be painted.

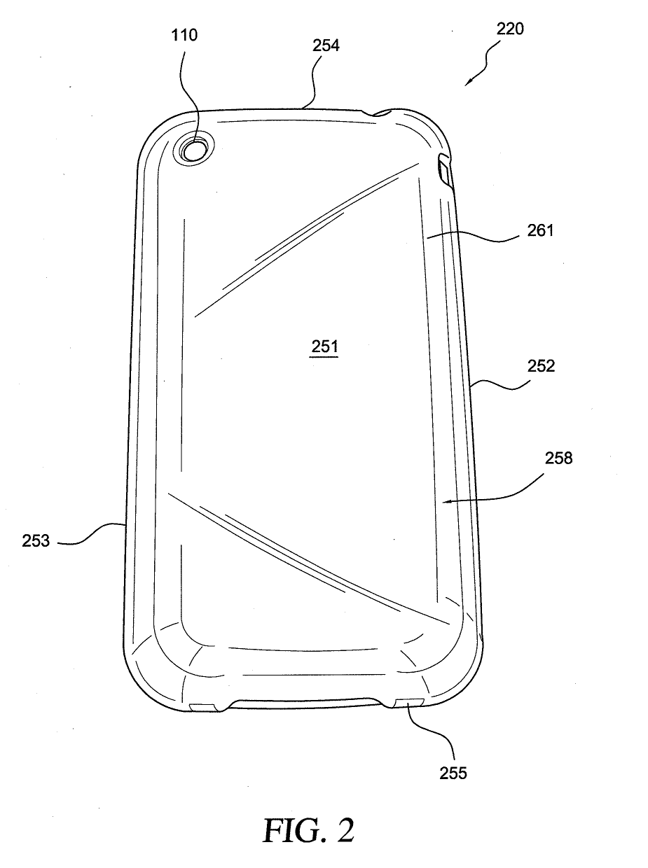

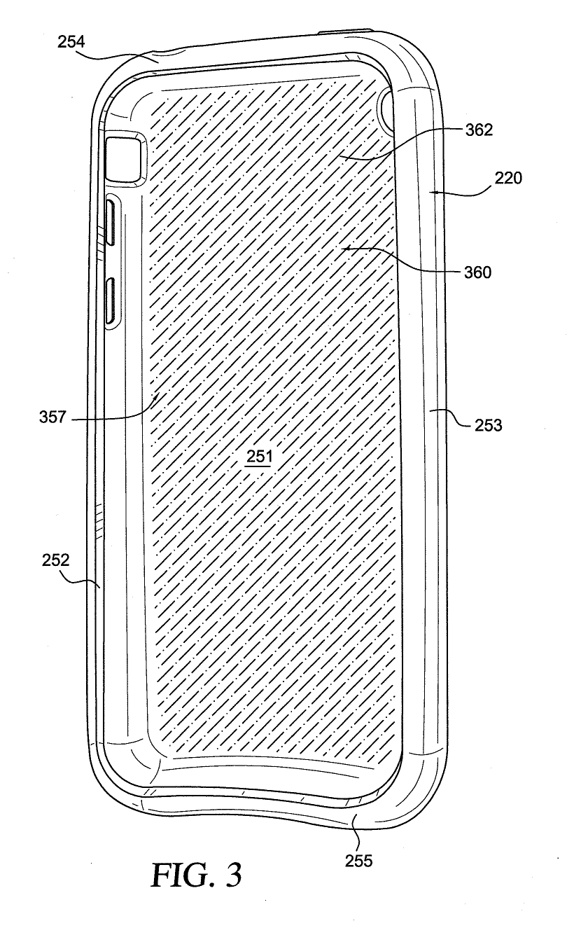

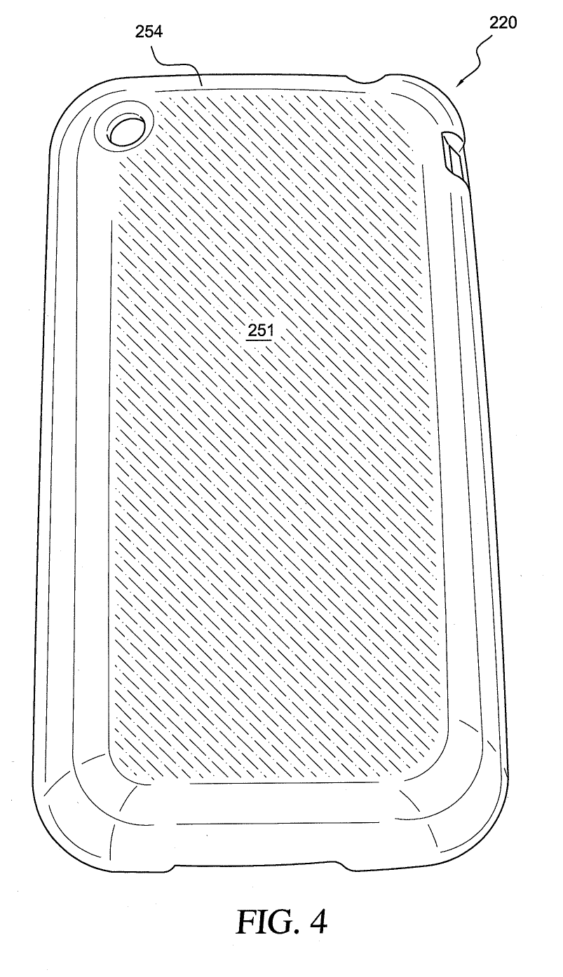

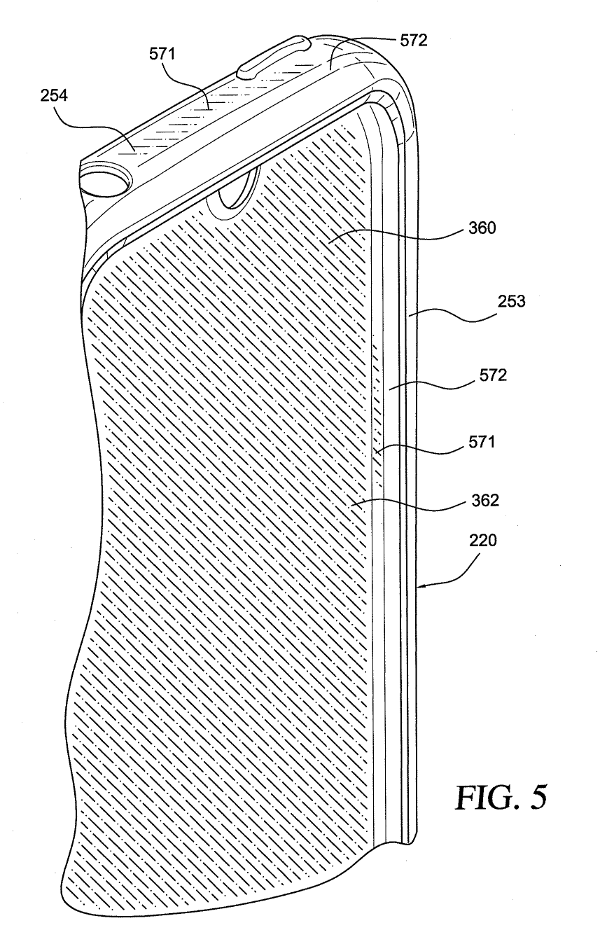

Yet other embodiments disclose a method of manufacturing a translucent mobile media device case. The method can include: feeding a carrier material into a machine tool; forming the translucent mobile media device case with the machine tool such that the translucent mobile media device case has an interior surface that is at least partially textured; and removing the translucent mobile media device case from the machine tool. Turning to the drawings, FIG. 2 is a rear view illustrating an embodiment of an exemplary mobile media device case 220 enclosing a mobile media device 110, according to a first embodiment. FIG. 3 is a front, right isometric view illustrating exemplary mobile media device case 220, according to the first embodiment. FIG. 4 is another rear view illustrating exemplary mobile media device case 220, according to the first embodiment. FIG. 5 is a top, front isometric view illustrating a part of exemplary mobile media device case 220, according to the first embodiment. As mobile media device case 220 is merely exemplary, it is not limited to the embodiments presented herein and can be employed in many different embodiments or examples not presented herein.

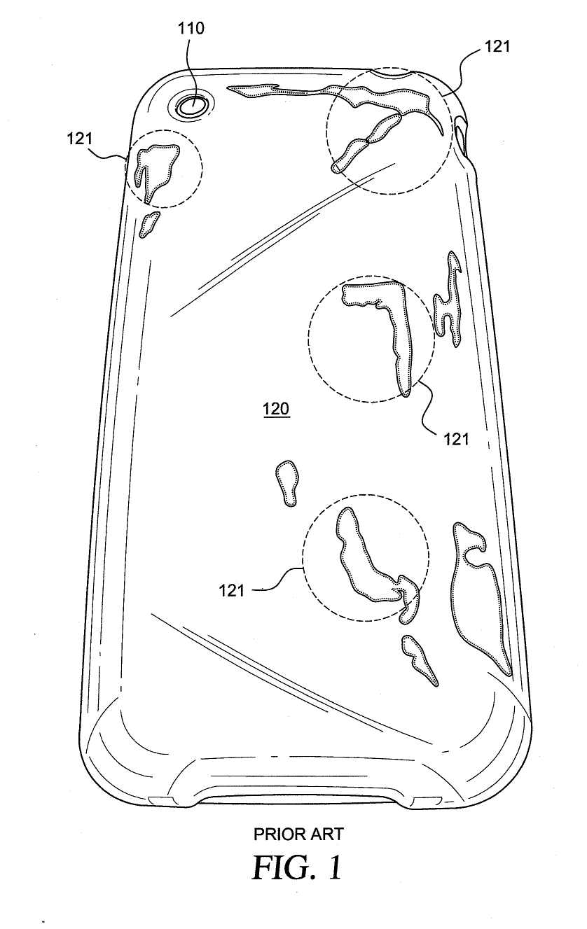

The term “mobile media device” should be broadly understood and includes electrical devices of all types and designs (e.g., smartphones, media players, telephones, audio-visual media players, and devices incorporating media players, telephones, and/or audio-visual devices). Examples of mobile media devices include smartphones, cellular (or mobile) telephones, laptop computers, audio playback devices, AM (amplitude modulated) and FM (frequency modulated) radios, CD (compact disk) players, and media (e.g., MP3 (MPEG Audio Layer-3)) players. In the embodiment shown in FIG. 1, mobile media device 110 can be implemented as any suitable Internet-connected, multimedia GSM smartphone, such as, for example the iPhone 3GS or iPhone 4G designed and marketed by Apple Inc. of Cupertino, Calif.

In some examples, mobile media device case 220 can include: (a) back wall 251; (b) one or more sidewalls 252, 253, 254, and 255. Back wall 251 and sidewalls 252, 253, 254, and 255 can define an interior 357 (FIG. 3) of the mobile media device case 220 with an interior surface 360 (FIG. 3). Back wall 251 and sidewalls 252, 253, 254, and 255 can also define an exterior 258 of the mobile media device case 220 with an exterior surface 261. Mobile media device case 220 can be configured to receive and hold mobile media device 110 (FIG. 1) within interior 357. Interior surface 360 (e.g., one or more of back wall 251 and/or sidewalls 252, 253, 254, and 255) can be modified to eliminate noticeable blemishes and imperfections are visible through mobile media device case 120 (FIG. 1).

In many examples, mobile media device case 220 is at least in part composed of a translucent (e.g., transparent) material. For example, mobile media device case 220 can be manufactured from any suitable translucent carrier material, such as, for example thermoplastic polyurethane (TPU) material. An example of a suitable TPU material for manufacturing mobile media device case 220 includes methylene diphenylene (MDI) and polyhydric alcohols. In particular, TPU material part number 3690AUDPS056 available from Bayer MaterialScience AG of Leverkusen, Germany can be used. The use of TPU as a material to form a protective carrier for a mobile media device is advantageous because TPU is lightweight, transparent or at least translucent, malleable, and flexible.

In various embodiments, at least a part of interior surface 360 can be a textured interior surface. In these embodiments, mobile media device case 220 is configured to reduce substantially the blemishes and imperfections associated with enclosing mobile media device 110 within a respective to mobile media device case 120.

In some embodiments, mobile media device case 220 is configured to include a texturing 362 at interior surface 360. For example, texturing 362 can include a fine random markings in interior surface 360. In other examples, texturing 362 can include a pattern of markings or a random-looking pattern of markings in interior surface 360. In some examples, the depth of texturing 362 can be less than 0.5 millimeters. For example, texturing 362 can have a depth of 0.25 millimeters. In many examples, after interior surface 360 is textured, mobile media device case 220 can still be translucent. For example, the textured portion of mobile media device case 220 can have a frosty appearance.

In some embodiments, the whole interior surface 360 of mobile media device case 220 can include texturing 362. In other embodiments, only a portion of interior surface 360 has texturing 362. For example, a first portion of the exterior surfaces of mobile media device 110 can contact a first part of interior surface 360 when mobile media device case 220 holds mobile media device 110. If the first portion of the exterior surfaces of mobile media device 110 is polished or smooth, the first part of interior surface 360 of mobile media device case 220 can be textured. For example, if a back exterior surface of mobile media device 110 is a polished plastic, the interior surface of back wall 251 can be textured. If the sidewalls of mobile media device 110 are a polished plastic or metal, the interior surface of sidewalls 252, 253, 254, and/or 255 can likewise be textured.

In the example shown in FIGS. 2-5, mobile media device 110 is a iPhone 3GS. On the iPhone 3G, the back and part of the sidewalls are polished plastic. In this example, the interior surface of back wall 251 is textured. As partially shown in FIG. 5, a first part 571 of sidewalls 252, 253, 254, and 255 can be textured, and a second part 572 of sidewalls 252, 253, 254, and 255 is not textured.

In the above described embodiment, adding texturing to interior surface 360 reduces the size and total area of contact between the interior surface of the device protective carrier and the back surface of the computing device, thereby dispersing/minimizing the points of contact between the two surfaces resulting in removal of perceived blemishes and imperfections when the portable multi-media computing device is enclosed within either type of modified device protective carrier.

Texturing 362 can be added to interior surface 360 using any suitable texturing process, such as, for example an electrical discharge machining (EDM) process identified as YS1281 as supplied by Hong Kong Yick Sang Metal and Plastic Mould Texturing Limited of Hong Kong, China. In other examples, texturing 362 can be added to interior surface 360 after mobile media device 110 is molded by for example, scuffing interior surface 360.

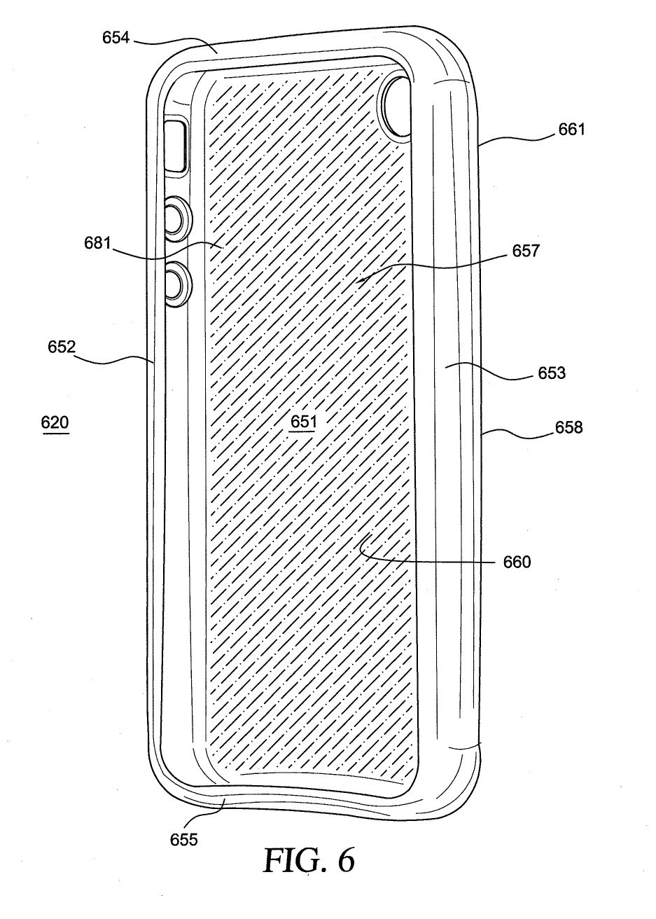

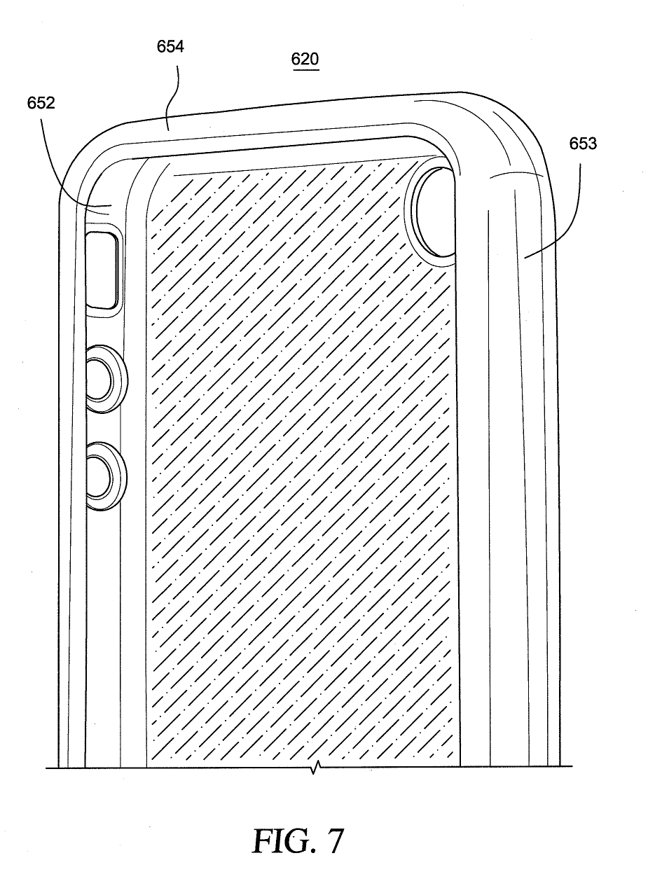

FIG. 6 is a front, right view illustrating an embodiment of another exemplary mobile media device case 620, according to a second embodiment. FIG. 7 is a right, front isometric view illustrating a part of exemplary mobile media device case 620, according to the second embodiment. As mobile media device case 620 is merely exemplary, it is not limited to the embodiments presented herein and can be employed in many different embodiments or examples not presented herein.

In some examples, mobile media device case 620 can include: (a) back wall 651; (b) one or more sidewalls 652, 653, 654, and 655. Back wall 651 and sidewalls 652, 653, 654, and 655 can define an interior 657 of the mobile media device case 620 with an interior surface 660. Back wall 651 and sidewalls 652, 653, 654, and 655 can also define an exterior 658 of the mobile media device case 620 with an exterior surface 661. Mobile media device case 620 can be configured to receive and hold a mobile media device (not shown) within interior 657. Interior surface 660 (e.g., one or more of back wall 651 and/or sidewalls 652, 653, 654, and 655) can be modified to eliminate noticeable blemishes and imperfections are visible through mobile media device case 120 (FIG. 1). Mobile media device case 620 can be similar to mobile media device case 220 (FIG. 2) except that mobile media device case 620 can be configured to receive and hold an iPhone 4G instead of an iPhone 3G.

In this example, the back wall of the iPhone 4G is polished glass and all of the sidewalls of the iPhone 4G are metal. In this example, the interior surface 681 of back wall 251 is textured. The interior surfaces of sidewalls 652, 653, 654, and 655 are not textured because the sidewalls of the iPhone 4G are not polished or smooth.

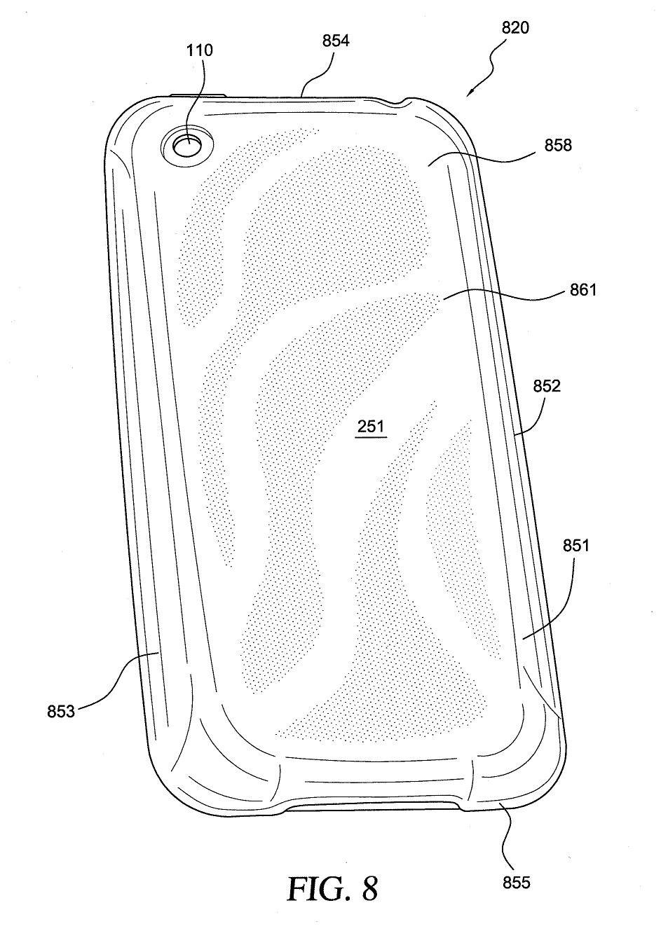

Turning to another embodiment, FIG. 8 is a rear view illustrating an embodiment of an exemplary mobile media device case 820 enclosing mobile media device 110, according to a third embodiment. As mobile media device case 820 is merely exemplary, it is not limited to the embodiments presented herein and can be employed in many different embodiments or examples not presented herein.

In some examples, mobile media device case 820 can include: (a) back wall 851; (b) one or more sidewalls 852, 853, 854, and 855. Back wall 851 and sidewalls 852, 853, 854, and 855 can define an interior of the mobile media device case 820 with an interior surface. Back wall 851 and sidewalls 852, 853, 854, and 855 can also define an exterior 858 of the mobile media device case 820 with an exterior surface 861. Mobile media device case 820 can be configured to receive and hold mobile media device 110 (FIG. 1) within the interior. The interior surface (e.g., one or more of back wall 851 and/or sidewalls 852, 853, 854, and 855) can be modified to eliminate noticeable blemishes and imperfections are visible through mobile media device case 120 (FIG. 1).

In various embodiments, the interior surface can be a painted interior surface. In these embodiments, mobile media device case 820 is configured to reduce substantially the blemishes and imperfections associated with enclosing mobile media device within a respective to mobile media device case 120.

In the same or different examples, mobile media device case 820 can be configured to include a matte painted interior via any suitable matte painting process, such as, for example a spray painting process followed by a baking process available from or as implemented by Jame Technology Co., Ltd. of Longhua town, SZ, China.

In one embodiment, the spray painting process occurs while the TPU material is cooling during the molding process. In this embodiment, after the spray painting process occurs, an oven baking process is performed to dry the paint before the TPU material has completely cooled. In an example, the matte paint can comprise approximately seventy percent solvent, twenty-five percent thermoplastic resin, and five percent adhesion promoter. In this embodiment, the matte paint can be an oil-based paint or a water-based paint. In one embodiment, a water-based paint from Kaili Plastic Vacuum Plating, Ltd. in China can be used.

In the above described embodiments, matte paint on interior surface 860 reduces the size and total area of contact between the interior surface of the device protective carrier and the back surface of mobile media device 110, thereby dispersing/minimizing the points of contact between the two surfaces resulting in removal of perceived blemishes and imperfections when mobile media device 110 is enclosed in mobile media device case 820.

In some embodiments, the whole interior surface 860 of mobile media device case 820 can be painted. In other embodiments, only a portion of the interior surface is painted. For example, a first portion of the exterior surfaces of mobile media device 110 can contact a first part of the interior surface when mobile media device case 820 holds mobile media device 110. If the first portion of the exterior surfaces of mobile media device 110 is polished or smooth, the first part of the interior surface of mobile media device case 820 can be painted. For example, if a back exterior surface of mobile media device 110 is a polished plastic, the interior surface of back wall 851 can be painted. If the sidewalls of mobile media device 110 are a polished plastic or metal, the interior surface of sidewalls 852, 853, 854, and/or 855 can likewise be painted.

In other examples, at least a portion of the interior surface of mobile media device case 820 can also include a texture. The textured surface can be similar or identical to texturing 362 of FIGS. 3 and 8, respectively.

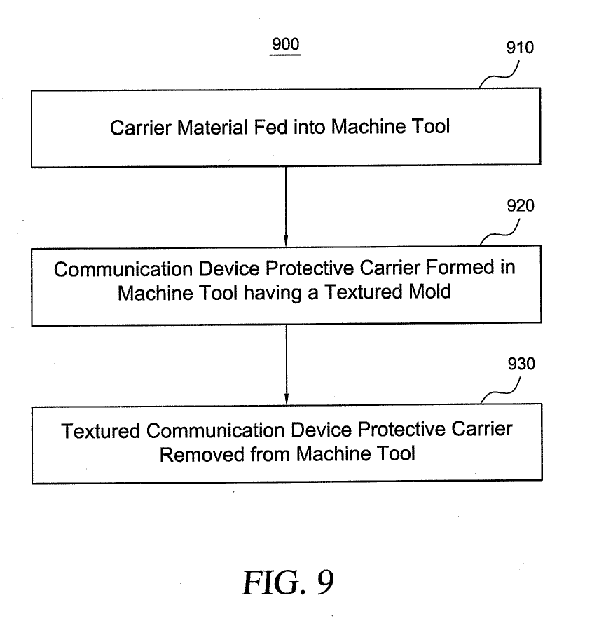

FIG. 9 is an operational flow diagram generally illustrating a method 900 for manufacturing a mobile media device case. As method 900 is merely exemplary, it is not limited to the embodiments presented herein and can be employed in many different embodiments or examples not presented herein. In some implementations, certain activities of method 900 are combined, performed simultaneously or in a different order, without deviating from the objective of method 900. In some examples, method 900 can be used to produce mobile media device case 220 or 620 of FIGS. 2 and 6, respectively.

Method 900 begins at activity 910 of a carrier material being fed into a machine tool. In some embodiments, any suitable carrier material is fed into the machine tool, such as, a thermoplastic polyurethane (TPU) material that includes methylene diphenylene (MDI) and polyhydric alcohols. As an example, TPU material part number 3690AUDPS056 available from Bayer MaterialScience AG of Leverkusen, Germany can be used.

At activity 920, a mobile media device case is formed within the machine tool including a mold having a textured surface. In some embodiments, the mobile media device case is formed within the mold of the machine tool using any suitable methodology, such as, for example an injection molding methodology. In an example and referring to FIGS. 2 and 6 above, mobile media device case 220 or 620 is formed within the machine tool that includes a mold having a textured surface. In other embodiments, one or more surfaces of the mold within the machine tool are pre-treated to produce a texture surface, such as, for example on the interior surface of the communication device protective carrier. Examples of surface pre-treatments of the mold include chemically etching the mold surface, laser etching the mold surface, sand blasting the mold surface, electrical discharge machining (EDM) the mold surface and the like. In an example, the surface of the mold can be the subject of EDM to apply a YS 1281 texture available from HongKong Yick Sang Metal and Plastic Mould Texturing Limited of Hong Kong. In still other embodiments, a texture can be applied to the interior surface of the mobile media device case after the carrier is ejected from the machine.

At activity 930, the textured mobile media device case is removing from the machine tool, and method 900 is complete.

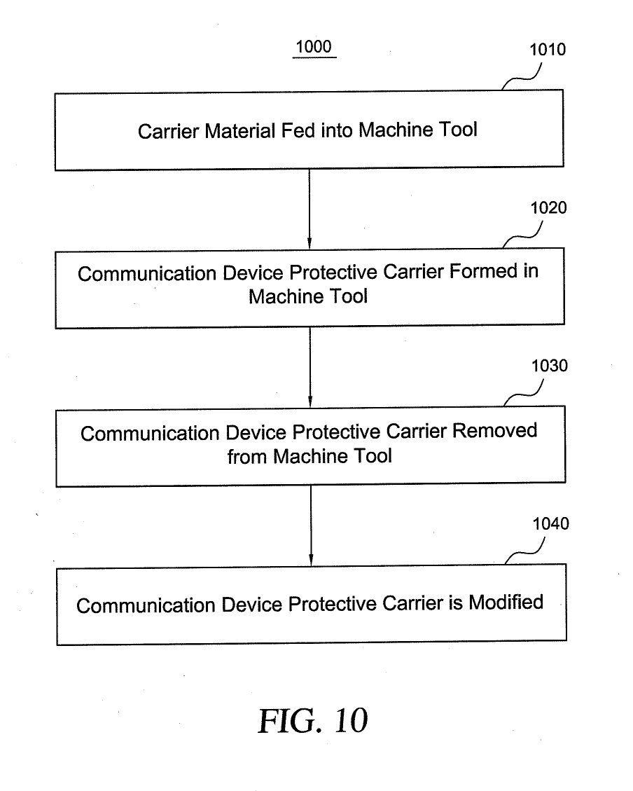

FIG. 10 is an operational flow diagram generally illustrating a method 1000 for manufacturing a mobile media device case. As method 1000 is merely exemplary, it is not limited to the embodiments presented herein and can be employed in many different embodiments or examples not presented herein. In some implementations, certain activities of method 1000 are combined, performed simultaneously or in a different order, without deviating from the objective of method 1000. In some examples, method 1000 can be used to produce mobile media device case 820 of FIG. 8.

Method 1000 begins with activity 1010 of a carrier material being fed into a machine tool. In some embodiments, any suitable carrier material is fed into the machine tool, such as, a thermoplastic polyurethane (TPU) material including methylene diphenylene (MDI) and polyhydric alcohols, for example 3690AUDPS056 available from Bayer MaterialScience AG of Leverkusen, Germany.

At activity 1020, a mobile media device case is formed within the mold of the machine tool. In some embodiments, the mobile media device case is formed within the mold of the machine tool using any suitable methodology, such as, for example an injection molding methodology.

At activity 1030, the mobile media device case is ejected from the machine tool.

At activity 1040, the mobile media device case is modified after removal from the machine tool. In some embodiments, mobile media device case is modified after removal from the machine tool and the interior of the mobile media device case is exposed and modified. In such embodiments, the interior of the mobile media device case is matte painted via any suitable matte painting process, such as, for example a mist or spray painting process available from or as implemented by Jame Technology Co., Ltd. of Longhua town, SZ, China. As indicated above, the painting process can include a baking process. Additionally or alternatively, the interior of the mobile media device case can be chemically etched, laser etched, sand blasted, EDM processed, and the like, before, during, or after the painting process. In some of these embodiments, a texture is applied to the internal surface of the mobile media device case after the communication device protective carrier is ejected from the machine tool.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. The foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A mobile media device case configured to receive and hold a mobile media device, the mobile media device case comprising:
a back wall; and
one or more sidewalls coupled to the back wall,
wherein:
the mobile media device case is translucent;
the back wall and the one or more sidewalls define an interior of the mobile media device case and an interior surface;
the mobile media device case is configured to receive and hold the mobile media device within the interior of the mobile media device case; and
at least a first portion of the interior surface comprises texturing.

2. The mobile media device case of claim 1, wherein:
a first portion of the mobile media device has a polished exterior surface; and
the mobile media device case is configured such that the at least the first portion of the interior surface is in contact with the first portion of the mobile media device when the mobile media device case holds the mobile media device in the interior of the mobile media device case.

3. The mobile media device case of claim 1, wherein:
the at least the first portion of the interior surface comprises an interior surface of the back wall.

4. The mobile media device case of claim 1, wherein:
the at least the first portion of the interior surface comprises at least a first part of an interior surface of the one or more sidewalls.

5. The mobile media device case of claim 4, wherein:
at least a second part of the interior surface of the one or more sidewalls is devoid of the texturing.

6. The mobile media device case of claim 1, wherein:
the texturing comprises one or more grooves in the at least the first portion of the interior surface; and
the one or more grooves have a depth of less than 0.5 millimeters.

7. The mobile media device case of claim 1, wherein:
the texturing comprises a pattern of markings in the at least the first portion of the interior surface.

8. The mobile media device case of claim 1, wherein:
the back wall and the one or more sidewalls comprise a thermoplastic polyurethane material.

9. The mobile media device case of claim 1, wherein:
the mobile media device case is transparent.

10. A mobile media device case configured to receive and hold a mobile media device, the mobile media device case comprising:
a back wall; and
one or more sidewalls coupled to the back wall,
wherein:
the mobile media device case is translucent;
the back wall and the one or more sidewalls define an interior of the mobile media device case and an interior surface;
the mobile media device case is configured to receive and hold the mobile media device within the interior of the mobile media device case; and
at least a first portion of the interior surface is painted.

11. The mobile media device case of claim 10, wherein:
a first portion of the mobile media device has a polished exterior surface; and
the mobile media device case is configured such that the at least the first portion of the interior surface is in contact with the first portion of the mobile media device when the mobile media device case holds the mobile media device in the interior of the mobile media device case.

12. The mobile media device case of claim 10, wherein:
the at least the first portion of the interior surface comprises an interior surface of the back wall.

13. The mobile media device case of claim 10, wherein:
the at least the first portion of the interior surface comprises at least a first part of an interior surface of the one or more sidewalls.

14. The mobile media device case of claim 13, wherein:
at least a second part of the interior surface of the one or more sidewalls is devoid of the paint.

15. The mobile media device case of claim 10, wherein:
the paint comprises approximately seventy percent solvent, approximately twenty-five percent thermoplastic resin, and approximately five percent adhesion promoter.

16. The mobile media device case of claim 10, wherein:
the back wall and the one or more sidewalls comprise a thermoplastic polyurethane material.

17. A method of manufacturing a translucent mobile media device case, the method comprising:
feeding a carrier material into a machine tool;
forming the translucent mobile media device case with the machine tool such that the translucent mobile media device case has an interior surface that is at least partially textured; and
removing the translucent mobile media device case from the machine tool.

18. The method of manufacturing of claim 17, wherein:
forming the translucent mobile media device case comprises:
injection molding the translucent mobile media device case such that the translucent mobile media device case has the interior surface that is at least partially textured.

19. The method of manufacturing of claim 17, wherein:
forming the translucent mobile media device case comprises:
pretreating at least a one or more surfaces of a mold for the machine tool to include a textured surface.

20. The method of manufacturing of claim 17, wherein:
forming the translucent mobile media device case comprises:
forming a back wall of the translucent mobile media device; and
forming one or more sidewalls of the translucent mobile media device adjacent to the back wall.

21. The method of manufacturing of claim 17, wherein:
feeding the carrier material into the machine tool comprises:
feeding a thermoplastic polyurethane material into the machine tool; and
the carrier material comprises the thermoplastic polyurethane material.
